(19) United States
(12) Patent Application Publication
(10) Pub. No.: US 2005/0241675 A1
(43) Pub. Date: Nov. 3, 2005

(54) Water guide for dishwasher and dishwasher having the same

(76) Inventors: Moon Kyu Jung, Geumjeong-gu (KR); Kap Soo Shin, Cheongwon-gun (KR)

Correspondence Address: FLESHNER & KIM, LLP, P.O. BOX 221200, CHANTILLY, VA, 20153, US

(21) Appl. No.: 11/101,633

(22) Filed: Apr. 8, 2005

(30) Foreign Application Priority Data
May 3, 2004 (KR) P2004-0030960
May 3, 2004 (KR) P2004-0030957
May 20, 2004 (KR) P2004-0035895

(51) Int. Cl. B08B 7/04; B08B 9/20

(52) U.S. Cl. 134/18; 134/56 D; 134/58 D; 134/25.2

(57) ABSTRACT

A water guide for guiding the flow of water in a dishwasher via a sump maintains a precise level of water in the sump by directly measures an actual water level of the sump. The water guide includes a supply channel for supplying washing water to the sump; and a sensor configuration, installed along the supply channel, for sensing a water level of washing water contained in the sump.

### CROSS-REFERENCE TO RELATED APPLICATIONS

This application claims the benefit of Korean Application No. 10-2004-0030957 and No. 10-2004-0030960, each filed on May 03, 2004, and No. 10-2004-0035895, filed on May 20, 2004, which are hereby incorporated by reference as if fully set forth herein.

### BACKGROUND OF THE INVENTION

1. Field of the Invention

The present invention relates to dishwashers, and more particularly, to a water guide for guiding the flow of water in a dishwasher via a sump by integrating a sensor configuration to maintain a precise level of water in the sump.

2. Discussion of the Related Art

A dishwasher is an apparatus for washing dishes and other articles to be washed, which are loaded onto at least one rack slidably mounted inside a tub, by spraying via one or more sprayers the loaded articles with water mixed with detergent and/or other solutes, i.e., washing water. The dishwasher is operated cyclically, including one or more wash cycles followed by one or more rinse cycles. A sump for receiving storing the washing water is provided under the tub and is connected to a water guide, which performs simultaneously the functions of guiding water being supplied to the sump via a supply channel and guiding water being drained from the sump via a drain channel. The water guide is a unified module integrating the supply channel and the drain channel and includes a flow meter for measuring the flow of water through the supply channel to be supplied to the sump.

Accordingly, in a water guide for a dishwasher as described above, the flow meter determines indirectly the level of water expected to be contained in the sump but cannot know the true water level present in the sump. Proper and efficient operation of the dishwasher, however, depends on an accurate determination of the water level of the sump, which varies according to dishwasher model and may vary over the course of a dishwashing cycle. Moreover, damage to the system can result from an oversupply or undersupply of washing water to the sump during operation.

### SUMMARY OF THE INVENTION

Accordingly, the present invention is directed to a water guide for a dishwasher that substantially obviates one or more problems due to limitations and disadvantages of the related art.

An object of the present invention is to provide a water guide for precisely controlling the amount of washing water supplied to a sump.

Another object of the present invention is to provide a water guide for regulating the amount of washing water contained in a sump.

Another object of the present invention is to provide a water guide in which a predetermined water level can be maintained in a sump.

Another object of the present invention is to provide a water guide which prevents the oversupply of washing water to a dishwasher.

Another object of the present invention is to provide a water guide which prevents the undersupply of washing water to a dishwasher.

Another object of the present invention is to provide a water guide which prevents damage to a dishwasher caused by an oversupply or undersupply of washing water.

Another object of the present invention is to provide a water guide which enhances the washing efficiency and reliability of a dishwasher.

Another object of the present invention is to provide a dishwasher suitable for implementing any of the above water guides.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages in accordance with the purpose of the invention, as embodied and broadly described herein, there is provided a water guide for a dishwasher having a sump. The water guide comprises a supply channel for supplying washing water to the sump; and a sensor configuration, installed along the supply channel, for sensing a water level of washing water contained in the sump.

The sensor configuration, sensing the water level using a buoyancy of the washing water in the supply channel, controls the supply of washing water via the supply channel to the sump according to the sensed water level, to cut off the supply of washing water when the water level of the sump reaches a predetermined water level and to drain washing water from the sump when the water level of the sump exceeds the predetermined water level.

Preferably, the sensor configuration comprises a float, movably disposed within a float chamber, the float having an elevation based on the sensed water level; and a sensing device operated by the movement of the float, wherein the float chamber communicates with the sump by communicating with the supply channel.

According to preferred embodiments of the present invention, the sensing device may be a contact switch activated by applying an external physical force, the external physical force being generated by the movement of the float or may be a set of non-contact switches activated by applying an external magnetic force, the external magnetic force likewise being generated by the movement of the float.

A water blocking unit is preferably applied to the supply channel to counter rising water levels in the float chamber and to protect electrical components of the sensor configuration from exposure to washing water escaping the supply channel.

The water guide further comprises a drain channel for draining washing water from the sump, the drain channel having an inverted U-shape configuration for draining washing water from the sump. The drain channel experiences a high water pressure during the controlled draining of the sump and experiences a reduced water pressure when the controlled for draining washing water from the sump ends. Therefore, preferably, a release valve assembly is disposed in the drain channel adjacent the apex of the inverted U-shaped configuration and is configured to facilitate a controlled draining of the sump by selectively introducing external air to the drain channel to apply atmospheric pressure to an interior of the drain channel when the water pressure in the drain channel is reduced by the ending of the controlled for draining washing water from the sump.

According to the present invention a conventional flow meter may be disposed in the supply channel for measuring the flow of water through the supply channel to be supplied to the sump. The sensed level of washing water contained in the sump, however, is determined separately from the measured flow of water through the supply channel to be supplied to the sump.

In another aspect of the present invention, there is provided a dishwasher comprising a tub for receiving articles to be washed; a sump, disposed under the tub, for collecting and storing washing water; and the above-described water guide.

The water guide according to the present invention uses a novel method to control a water level in a sump of a dishwasher. The method comprises supplying water to the sump; detecting, at the supply channel, a water pressure resulting from the supplied water; and outputting a predetermined electrical signal based on the detected water pressure, wherein the output predetermined electrical signal is applied to one of a supply valve connected to an external water source and a drain pump connected to the sump, the supply valve thereby controlling the supply of water to the supply channel and the drain pump thereby controlling the draining of washing water from the draining channel.

Accordingly, the present invention directly measures an actual water level of the sump, enabling washing water to be precisely supplied to the sump and then to be maintained at a predetermined water level.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a partially cutaway, side sectional view of a dishwasher according to the present invention;

FIG. 2 is a cross-sectional view of a water guide for a dishwasher according to a first embodiment of the present invention;

FIG. 3 is a cross-sectional view of a water guide for a dishwasher according to a second embodiment of the present invention;

FIG. 4 is a cross sectional of a water guide of FIG. 3 or FIG. 4 in accordance with a preferred embodiment of the present invention; and

FIG. 5 is a cross sectional view taken along the line I-I of FIG. 3 and showing a check valve of a water guide.

### DETAILED DESCRIPTION OF THE INVENTION

Reference will now be made in detail to the preferred embodiments of the present invention, examples of which are illustrated in the accompanying drawings. Wherever possible, like reference numbers will be used throughout the drawings to refer to the same or similar elements.

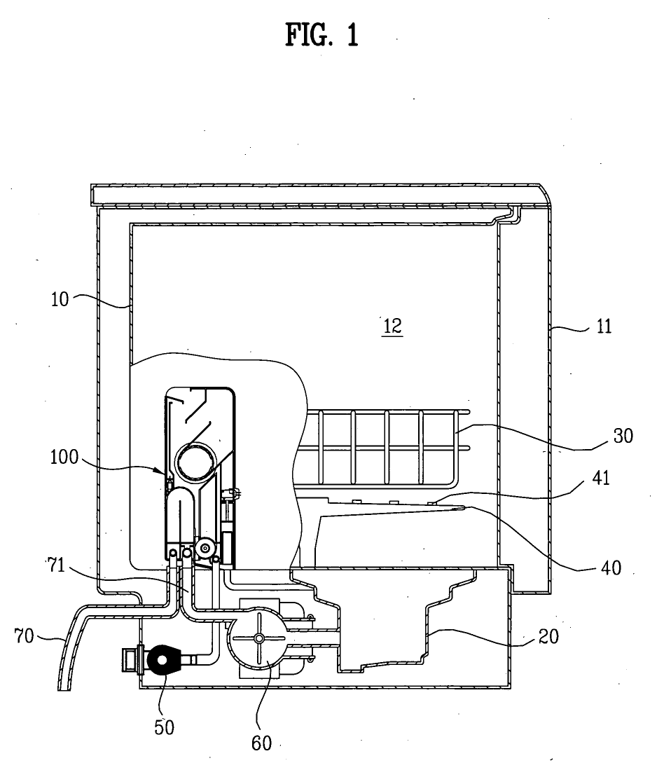

FIG. 1 illustrates a dishwasher in accordance with the present invention and an example of a water guide provided in the dishwasher. The dishwasher includes a tub 10 one side of which is provided with a door 11 for accessing a washing chamber 12, which is established by the interior of the tub when the door is closed and which may house at least one rack 30 for loading articles to be washed. The rack 30 is slidably mounted inside the washing chamber 12 so that, when the door 11 is opened, the rack can be manually slid out (partially extracted) from the washing chamber. The washing chamber 12 also houses at least one sprayer 40, which is correspondingly and rotatably disposed adjacent the at least one rack 30 and is provided with a set of nozzles 41 through which washing water is forced obliquely and sprayed toward the rack. The reaction force generated by the washing water exiting the nozzles 41 rotates the sprayer 40 for a thorough and even spraying action over any articles placed in the rack 30.

During operation of the dishwasher for a wash or rinse cycle, the washing water sprayed into the washing chamber 12 via the sprayer 40 originates from a sump 20 for receiving and storing washing water, which is pumped from the sump into the sprayer by a main pump (not shown) coupled to the sump. The sump 20 is provided below the tub 10 and in effect forms a bottom surface of the washing chamber 12, so that the sprayed washing water is contained in the washing chamber and is allowed to drain back into the sump as contaminated water to be filtered for reuse by a filter (not shown) typically provided at an upper surface of the sump. Upon initial operation of a dishwasher cycle, clean (uncontaminated) water from an external source (not shown) is supplied to the sump 20 through a supply valve 50, which may incorporate a supply pump (not shown) to supplement the water pressure of the external source, connected to the sump by way of a water guide 100. Thus, the water guide 100 guides the flow of clean water being supplied to the sump 20.

Upon completion of a wash or rinse cycle, the contaminated washing water is discharged (drained) from the dishwasher, specifically, from the sump 20, using a drain pump 60 coupled between the sump and the water guide 100, which communicates with the exterior of the dishwasher via a drain hose 70. When a draining operation is completed, the sump 20 may be resupplied with clean washing water for a subsequent wash or rinse cycle. An intermediate drain hose 71 connects the water guide 100 with the sump 20, and the drain pump 60 is disposed in-line with the intermediate drain hose and is thus coupled to each of the water guide and sump. Accordingly, the water guide 100 guides the flow of contaminated washing water being discharged from the sump 20. The draining operation will be later described in more detail in connection with a release valve assembly 420.

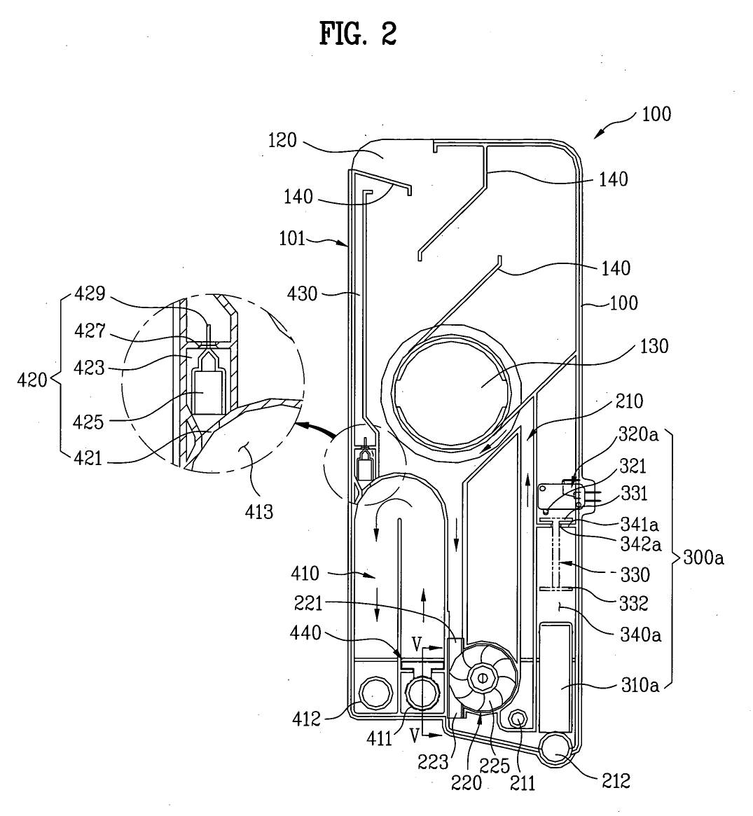

The above-described water guide 100 is coupled to an outer surface of the tub 10 and includes a supply channel and a drain channel, which are integrated into a unified module and are preferably disposed, adjacent each other, in a lower portion of the water guide. The supply channel and drain channel of the water guide 100 are each disposed with a casing defining an inner space of the water guide so as to communicate respectively with the sump 20. The water guide 100 is applicable to all kinds of dishwashers and will be described in more detail with reference to FIG. 2.

Referring to FIG. 2, the water guide 100 essentially comprises a casing 101, typically of molded plastic, defining an airtight inner space enclosed by a casing cover (not shown) and having a plurality of interior walls forming all internal components of the water guide, specifically including a supply channel 210 for guiding clean water and a drain channel 410 (described later) for guiding contaminated water. The inner space of the water guide 100 communicates with the atmosphere (exterior of the dishwasher) via an air inlet 120 provided at an upper point of the casing 101 and communicates with the interior of the tub 10, i.e., with the washing chamber 12, via an overflow port 130 of the water guide. Thus, the interiors of the tub 10 and water guide 100 are kept at atmospheric pressure to prevent any positive or negative pressurization that could develop in the system and particularly within the casing 101, which would interfere with the supply and drainage of washing water. A series of baffles 140 are provided to form an S-shape passage through the water guide's inner space, for impeding a transmission of noise generated inside the tub 10 and thus reducing the level of noise escaping the tub via the overflow port 130, the inner space, and the air inlet 120.

The supply channel 210 has a supply inlet 211 for coupling with the supply valve 50 and a supply outlet 212 for coupling with the sump 20 and is configured so that the supply inlet and supply outlet are both disposed at a low point of the water guide 100. When the supply valve 50 is opened, clean washing water is passed through the supply channel 210 and supplied to the sump 20. The flow of the thus-supplied washing water may be measured using a flow meter 220 comprising an impeller 225, flow meter inlet 221, and flow meter outlet 223, which are conventionally arranged inside the supply channel 210 so that the flow meter inlet is disposed higher than the flow meter outlet. In measuring the supplied washing water, the impeller 225 is rotated by the force of falling water passing through the impeller from the flow meter inlet 221 to the flow meter outlet 223, and the rotations are counted. While this vertical orientation of the flow meter 220 facilitates the measurement of smaller amounts of water by reliably rotating the impeller 225, there may be failures in obtaining a precise measurement consistently, since the flow meter merely uses the impeller's rotational frequency. Furthermore, an imprecise measurement of the supply of washing water to the sump 20 cannot predict the amount of water contained in the sump, which should be maintained, throughout sump operation, at a predetermined water level for a proper operation of the dishwasher.

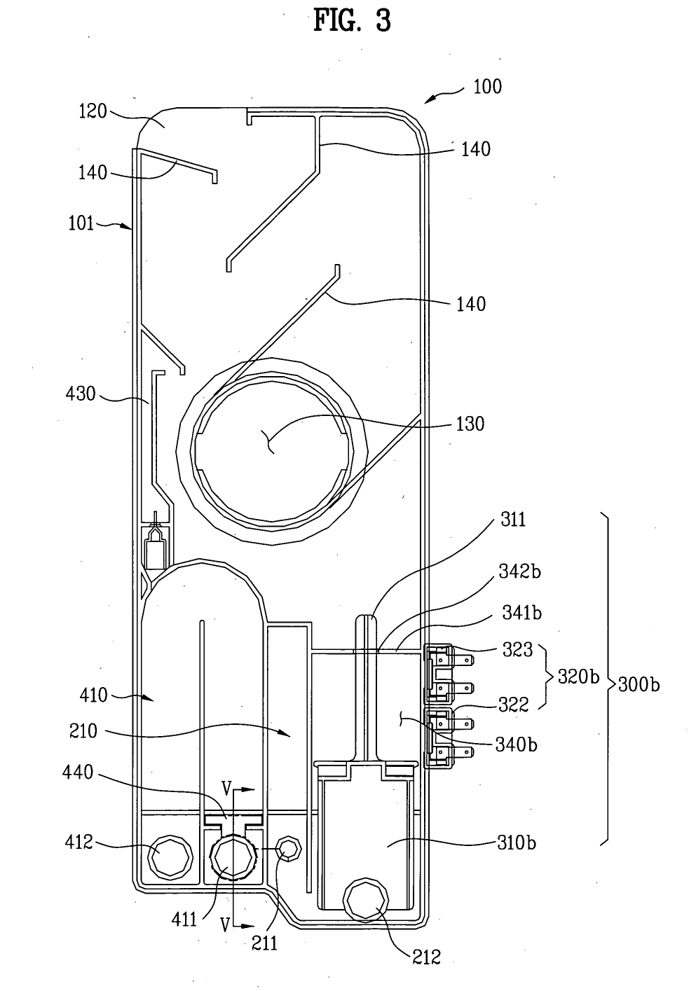

Therefore, the water guide 100 of the present invention is provided with a sensor configuration for sensing the water level contained in the sump 20, irrespective of the measurement or operation (readings) of the flow meter 220, and for outputting a water level control signal for controlling the water level of the sump based on the sensed water level. According to the present invention, the sensor configuration may be provided to the water guide 100 in addition to a flow meter such as that shown in FIG. 2, and thus be used in tandem with readings taken by the flow meter, or may (as exemplified in FIG. 3) be provided in lieu of such a flow meter.

Referring again to FIG. 2, illustrating a first embodiment of the water guide 100, a sensor configuration 300a includes a float 310a, movably supported within and guided by a float chamber 340a communicating with the supply channel 210, and a sensing device 320a, which includes a contact switch 321 operated (driven) by a direct application of an external physical force resulting from a specific movement (predetermined elevation) of the float. The float chamber 340a, which is vertically oriented, communicates with the sump 20 through the supply channel 210 at the supply outlet 212 and is arranged directly above the supply outlet. Accordingly, since the water level in the float chamber 340a follows the water level in the sump 20, by varying in direct proportion to the level of water present in the sump, and since the float chamber determines the movement of the float 310a, the elevation of the float within the float chamber corresponds directly to the water levels in the sump and can therefore be used to determine (detect) the water level in the sump. Also, due to its proximity to the supply outlet 212, the float 310a is kept free of contaminants and other particles by the passage of clean water being supplied through the supply outlet to the sump 20, thereby guarding against water guide malfunction and facilitating precise water level measurements.

The sensing device 320a is disposed directly above the float 310a, but preferably outside the float chamber 340a and supply channel 210, to react to the float's specific movement and thereby sense the presence of the predetermined water level in the sump 20. That is, when the float 310a reaches the predetermined elevation, the contact switch 321 of the sensing device 320a is activated, and the sensing device outputs a predetermined electrical signal for controlling the supply valve 50, which is closed to cut off the water supply to the sump 20. The predetermined electrical signal may also be used to control the drain pump 60. The contact switch 321 of the sensing device 320a may be operated by direct contact with the float 310a, which would then be provided with a push rod (not shown) for selectively abutting and activating the contact switch, or through an indirect contact using a plunger 330 having upper and lower contact plates 331 and 332 formed at either end of the plunger. In the event of the adopting a direct contact application, the push rod would extend upward from the float 310a, to move in unison with the float, but would necessitate an additional mechanism for ensuring a reliable operation of the float and an exact meeting of the rising push rod with the contact switch 321.

In the indirect contact application, which is preferable, the plunger 330 is vertically oriented and is supported by a float chamber partition 341a in which at least one through hole 342a is formed to receive the plunger and to guide its vertical movement. Thus, the plunger 300 is captured within the through hole 342a since the upper and lower contact plates 331 and 332, which are arranged in parallel, are disposed on opposite sides of the float chamber partition 341a. Specifically, the plunger 330 extends outside the float chamber 340a so that its upper contact plate 331 is disposed adjacent the contact switch 321 of the sensor 320a. Accordingly, when the float 310a rises within the float chamber 340a due to sufficient water levels, a primary contact occurring between the float and the lower contact plate 332 of the plunger 330 can be ensured, and when as a result of a further rising of the water level the float lifts the plunger, a secondary contact occurring between the plunger's upper contact plate 331 and the contact switch 321 can also be ensured. That is, as the water level of the float chamber 340a rises, the float 310a rises within the float chamber and first establishes contact with the plunger 330, after which the float and plunger continue to rise in unison, and when the water level reaches the predetermined water level, the plunger is raised further to press against the contact switch 321, which results in the output from the sensing device 320a of a predetermined electrical signal, to operate (i.e., close) the supply valve 50 and cut off the water supply to the sump 20. Conversely, the above primary and secondary contacts are disengaged in reverse sequence as the water level of the float chamber 340a recedes.

The capacity of the sump 20 and the predetermined water level corresponding to the sump both vary according to the dishwasher's capacity, which is set by a manufacturer according to model, so that the sensor configuration 300a needs to be adjustable to meet varying dishwasher conditions. Therefore, preferably, a predetermined gap exists between the float 310a and the plunger 330 when the float and plunger are at rest, and based on the predetermined gap, a precisely controlled operation of the plunger with respect to the sensing device 320a is enabled by simply varying the float properties (length, density, etc.) according to the desired predetermined water level. Thus, the water guide of the present invention can be easily adapted for application in any dishwasher, with any capacity and any sump's predetermined water level, by simply exchanging or modifying the float to correspond to the desired predetermined water level, with no modification of any other water guide components.

The sump 20 is typically provided with a heater (not shown) for heating the water in the sump, which communicates with the float chamber 340a. Thus, the water in the float chamber 340a is likewise heated water, producing water vapor that exits the float chamber via the through hole 342a and reaches the electrical components of the sensing device 320a, accelerating a corrosion of the contact switch 321. To counter this action, the upper contact plate 331 of the plunger 330 rests on the float chamber partition 341a, closing the through hole 342a, until the float 310a makes contact with the plunger.

According to a second embodiment of the present invention, the water guide 100 of FIG. 2 may, as a water guide 100′, adopt a sensor configuration 300b.

Referring to FIG. 3, illustrating the second embodiment of the present invention, the sensor configuration 300b includes a float 310b, movably supported within and guided by a float chamber 340b communicating with the supply channel 210, and a sensing device 320b, which includes a set of non-contact switches operated (driven) by an induced magnetic field resulting from a specific movement (predetermined elevation) of the float. Here, too, the float chamber 340b is vertically oriented, communicates with the sump 20 through the supply channel 210 at the supply outlet 212, and is arranged directly above the supply outlet; the water level in the float chamber 340b follows the water level in the sump 20, by varying in direct proportion to the level of water present in the sump; the float chamber determines the movement of the float 310b, whose elevation within the float chamber corresponds directly to the water levels in the sump and can therefore be used to determine (detect) the water level in the sump; and, due to its proximity to the supply outlet 212, the float 310b is kept free of contaminants and other particles by the passage of clean water being supplied through the supply outlet to the sump 20, thereby guarding against water guide malfunction and facilitating precise water level measurements.

In this case, however, the float 310b moving within the float chamber 340b is configured to generate the magnetic field for driving the non-contact switches and is provided, for example, with an internal magnet. The float 310b has a guide rod 311 extending upward from an upper surface of the float and passing through at least one through hole 342b formed in a float chamber partition 341b for receiving and vertically supporting the guide rod and for guiding its vertical movement. According to the second embodiment, as the float 310b is raised by a rising water level within the float chamber 340b, the internal magnet comes into increasingly closer proximity to the non-contact switches, which are preferably reed switches, and at a predetermined proximity corresponding to the predetermined elevation of the float, the sensing device 320b is activated to output a predetermined electrical signal for controlling (turning off) the supply valve 50 and, in a preferred embodiment, for controlling (turning on) the drain pump 60. In contrast to the first embodiment, the sensing device 320b is disposed along one side of the vertical movement of the float 310b, preferably fully outside the float chamber 340b, to react to the float's specific movement and thereby sense the presence of the predetermined water level in the sump 20. Here, the set of non-contact switches of the sensing device 320b includes a first switch 322 and a second switch 323 positioned above the first switch. By simply varying the relative positioning (e.g., respective mounting height) of the first and second switches 322 and 323 along the path of the float's vertical movement, the sensor configuration 300b is adjusted to meet specific and varying dishwasher conditions, i.e., as the capacity of the sump 20 and the predetermined water level corresponding to the sump vary according to the dishwasher's capacity. The first switch 322 is configured to be driven by the float 310b rising to an elevation within the float chamber 340b that corresponds to the water level in the sump 20 reaching the predetermined water level, and the second switch 323 is configured to be driven by the float rising further to an elevation within the float chamber that corresponds to the water level in the sump exceeding the predetermined water level. The predetermined electrical signal output from the sensing device 320b may be used to turn off the supply valve 50 upon activation of the first switch 322 and may be used to turn on the drain pump 60 upon activation of the second switch 323.

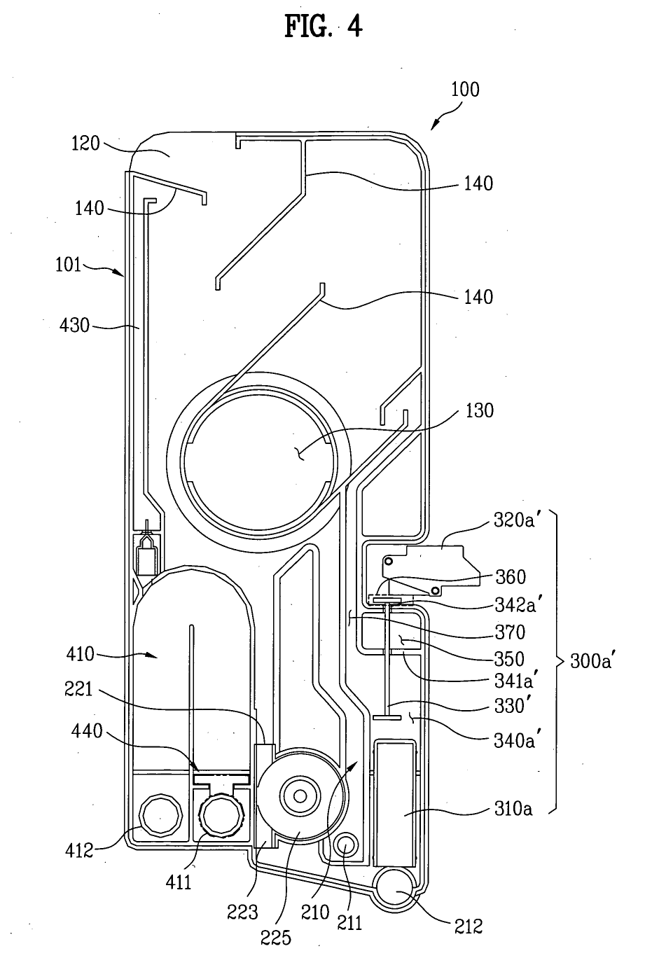

In either of the first and second embodiments, the sensing device 320a or 320b, as an electrical device, is prone to damage and failure if subject to contact with water, especially prolonged or repeated contact with washing water. To protect the sensing device 320a or 320b and particularly its switches from such contact, the entire device is disposed fully outside the supply channel 210, more particularly, outside the float chamber 340a or 340b, which communicates with the supply channel. The washing water flowing in the supply channel 210 freely enters the float chamber 340a or 340b and may exit (escape) the float chamber via the through hole 342a or 342b. Particularly in the case of the apparatus of the first embodiment, but potentially in the case of the apparatus of the second embodiment, washing water exiting the float chamber may come into contact with sensor components; the water guide of the present invention therefore preferably includes a water blocking unit as shown in FIG. 4, which is applied to the supply channel to counter rising water levels in the float chamber and thereby protect the sensing device from exposure to washing water escaping supply channel and, more specifically, the float chamber. Though illustrated more in relation to the apparatus of FIG. 2, the water blocking unit of the present invention may be adapted to be applied to the apparatus of FIG. 3 and is thus equally applicable to either the first or second embodiments.

Referring to FIG. 4, illustrating a water guide in accordance with the present invention, the water blocking unit comprises a buffer chamber 350 disposed between a float chamber 340a′ and a sensing device 320a′. The buffer chamber 350 is formed by a plurality of float chamber partitions 341a′ each having a through hole 342a′ for receiving a plunger 330′ of a sufficient length to pass through the buffer chamber from the float chamber 340a′ to the sensing device 320a′. The buffer chamber 350 has a sufficient interior volume to collect escaping washing water and thereby prevent the washing water from reaching the sensing device 320a′. An overflow drain 360 may be formed in the casing 101, immediately above the buffer chamber 350 but below the sensing device 320a′, to communicate with the exterior of the water guide 100 and thus allow washing water escaping the buffer chamber to be drained away before reaching the sensor. The overflow drain 360 may be formed to communicate with the tub 10.

The water blocking unit may further comprise a bypass channel 370 communicating with the float chamber 340a′ at an upper point of the float chamber, to thus communicate with the supply channel 210. The bypass channel 370 communicates at its upper end with the inner space of the water guide 100 and in turn the overflow port 130 formed in the casing 101, so that washing water, that may overflow the float chamber 340a′due to a large amount of washing water flowing rapidly through the supply channel 210, is shunted away from the through holes 342a′, the buffer chamber 350, and particularly the sensing device 320a′. Thus, regardless of the dishwasher's orientation (inclined, upside down, etc.), overflowing washing water of the supply channel 210 would be directed into the tub 10 through the bypass channel 370 rather than being leaked from the water guide 100.

In the operation of the sensor configuration 300a or 300b as described above, the predetermined electrical signal output from the sensing device 320a or 320b is input to a controller (not shown) for controlling the supply valve 50 and the drain pump 60. The controller generates corresponding control signals for application to the supply valve 50 and the drain pump 60 according to the water level detected in the sump 20 by the sensor configuration 300a or 300b of the water guide 100 or 100′ of the present invention. As clean water is supplied to the sump 20, the water level of the sump rises and approaches the predetermined water level, thus causing a corresponding rise in the water level in the float chamber 340a or 340b and in turn raising the float 310a or 310b, whose specific movement activates switches of the sensing device 320a or 320b, thereby generating and outputting a predetermined electrical signal to operate (i.e., close) the supply valve 50 and cut off the water supply to the sump 20. At this time, however, some unknown amount of washing water remains in the supply channel 210, i.e., along the flow route between the supply valve 50 and the sump 20, and continues to be supplied to the sump 20 even after the supply valve is closed. The water remaining in the supply channel 210 may be a significant amount but cannot be known precisely. As a result, the predetermined water level is exceeded by an unknown amount.

Therefore, since proper and efficient operation of the dishwasher depends on an accurate determination of the water level of the sump, which may vary over the course of a dishwashing cycle, the present invention also provides for a controlled draining of the sump, whereby the drain pump is temporarily driven so that some portion of the washing water may be drained from the sump. That is, the predetermined water level, which is generally set upon initiation of a wash or rinse cycle, may be variously set according to an operating condition of the dishwasher. To cope with such variations, the water guide of the present invention generates a water level control signal to control selectively the supply valve 50 and drain pump 60, thereby cutting off the washing water supply when the sump 20 is filled to a predetermined water level or partially draining the sump until reaching the predetermined water level again. An optimized washing water supply as above enhances the dishwasher's washing efficiency and reliability and prevents dishwasher damage that may result from an oversupply of washing water to the sump or an overflow of washing water in the system.

A controlled draining of the sump 20 as above, however, presents difficulties.

Meanwhile, the water guide 100 or 100′ of the present invention comprises a drain channel 410, which has an inverted U-shape configuration extending between a drain inlet 411 and a drain outlet 412, which are disposed near the bottom of the water guide but wholly above the sump 20 to guard against unimpeded and unintentional draining, for example, when the drain pump is turned off. The drain inlet 411 is connected to the drain pump 60, and indirectly to the sump 20, via the intermediate drain hose 71, while the drain outlet 412 is connected to the main drain hose 70 and thus communicates with the exterior of the dishwasher and atmospheric pressure. Accordingly, when activated, the drain pump 60 pumps the water contained in the sump 20 through the intermediate drain hose 71, into the drain channel 410 of the water guide 100, to be discharged from the dishwasher via the main drain hose 70. An apex 413 of the drain channel 410 is provided to ensure that the water flowing through the drain channel is raised to a higher elevation than the water level of the sump 20 by passing through the apex. Even though the drain channel 410 is arranged at a higher elevation than the sump 20 as described above, there may be operational conditions whereby undesired siphoning occurs due to a pressure differential existing between the drain channel and the sump. That is, the internal pressure of the drain channel 410 may drop below the atmospheric pressure applied to water in the sump 20, thereby raising the potential water level in the drain channel to a level beyond (higher than) the apex 413 and resulting in an undesirable facilitation of the above-described unimpeded draining and undesired siphoning, which counteracts any controlled draining to reach or maintain a predetermined water level in the sump 20.

Accordingly, as shown in FIG. 2, the water guide 100 or 100′ of the present invention preferably comprises a release valve assembly 420 disposed in the drain channel 410 adjacent the apex 413 and configured to facilitate a controlled draining of the sump 20 as desired and particularly to prevent unused washing water from being unnecessarily drained by the siphon phenomenon as mentioned above. To remove the siphon phenomenon, and more specifically, to release the pressure differential causing the siphon phenomenon, the release valve assembly 420 is configured to allow the apex 413 of the drain channel 410 to communicate selectively with the inner space of the water guide 100 or 100′, and in turn with the exterior of the casing 101, and in doing so, to selectively introduce external air to the drain channel. Therefore, since the siphon phenomenon needs to be released before the water level reaches the peak of the drain channel 410, the release valve assembly 420 is disposed adjacent the apex 413, i.e., at or near the drain channel's peak, to prevent a generation of the siphon phenomenon by opening a passage between the drain channel and the outer atmosphere only after a controlled completion of the drainage of used or excessive washing water from the sump 20.

The release valve assembly 420 includes a valve member 425 captured and movably housed within a valve chamber 423 communicating with the drain channel 410 via a first aperture 421, which is formed in an outer wall of the drain channel to open a passage to the interior of the apex 413, and communicating with an inner space of the water guide via a second aperture 427 and an air channel 430. Thus, air entering the water guide through the air inlet 120 can enter the valve chamber 423 through the second aperture 427 and be introduced to the drain channel 410 through the first aperture 421 according to the position of the valve member 425, which closes and opens the second aperture by reacting to the water pressure (buoyancy) in the drain channel 410. The valve member 425, preferably formed of a cylindrical body topped with a conic piece, is composed of a buoyant material having a specific density much lower than that of the washing water. When the valve member 425 is captured in the valve chamber 423, a needle 429 extending upward from an upper end of the valve member, and specifically from the pinnacle of its conic piece, is passed through the second aperture 427 to extend into the air channel 430. The needle 429 is provided to guard against a malfunctioning of the valve body 425 and to promote its operational reliability by guiding the vertical movement of the valve body within the valve chamber 423. The air channel 430 is a narrowed and extended passage of maximum length to keep the high pressure water of the drain channel 410, which may suddenly escape through the second aperture 427 upon initial operation of the drain pump 60 or due to a malfunction of the valve body 425, from entering the inner space of the water guide. Meanwhile, one of the baffles 140 may be disposed between the air inlet 120 and the upper end of the air channel 430 to similarly inhibit noise transmission.

In the operation of the release valve assembly 420 according to the present invention, the movement and resulting position of the valve member 425 is determined in coordination with an operation of the drain pump 60 to pump water through the drain channel 410, i.e., from the drain inlet 411 to the drain outlet 412. That is, when the drain pump 60 is driven, for example, in accordance with the predetermined electrical signal output from the sensing device 320a or 320b, water in the sump 20 is pumped into the drain channel 410, which experiences a rapid rise in its internal pressure, and the pumped water exits the water guide and is discharged from the dishwasher through the drain hose 70. In doing so, water passing through the drain channel 410 enters and fills the valve chamber 423 through the first aperture 421, to thereby raise the valve member 425 residing in the valve chamber 423. As the valve member 425 is thus lifted by the pressure and buoyancy of the water, the second aperture 427 is closed, such that the draining of the water in the sump 20 proceeds without leakage. On the other hand, a stopping of the drain pump 60, for example, upon reaching the predetermined water level in the sump 20, causes an immediate and rapid reduction in the pressure, the flow rate, and the amount of water carried in the drain channel 410, thereby lowering the pressure and water level in the valve chamber 423 and weakening water's buoyancy accordingly, allowing the valve member 425 to drop inside the valve chamber 423 and to open the second aperture 427 quickly. With the second aperture 427 thus opened, external air rushes into the drain channel 410 via the air inlet 120, the air channel 430, the second aperture 429, the valve chamber 423, and the first aperture 421, to thereby immediately lower the interior of the drain channel 410 to atmospheric pressure and thus forestall any siphoning. That is, the release valve assembly 420, which is sometimes called an air brake, prevents the generation of the siphon phenomenon is quickly returning the drain channel 410 to atmospheric pressure and immediately releasing its pressure differential with respect to the sump 20, so that drainage is automatically and completely stopped upon stopping the drain pump 60.

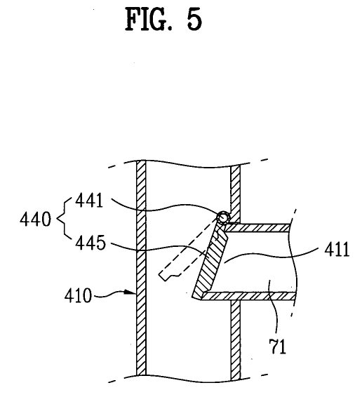

When the drain pump 60 is stopped and air is introduced into the drain channel 410 by the release valve assembly 420, there may be a reverse flow of water remaining in the drain channel. To prevent water from thus being returned to the sump 20 via the drain pump 60 along the intermediate drain hose 71, a check valve 440 including a hinge 441 and a shutter 445 is provided at the drain inlet 411 between the drain channel 410 and the intermediate drain hose 71. As shown in FIG. 5, the hinge 441 is disposed at a connection point between the drain channel 410 and the intermediate drain hose 71 and may be fixed either to an inner surface of the drain channel 410 or to one side of an opening of the intermediate drain hose 71, while the shutter 445 is rotatably provided on the hinge to open and close the drain inlet 411 or the opening of the intermediate drain hose. The opening of the intermediate drain hose 71 may be sloped to facilitate a seating of the shutter 445, and the intermediate drain hose may be connected the drain channel 410 perpendicularly or at some other angle, so that the shutter operates by means of its own weight when in a closed position, i.e., when the drain pump 60 is stopped, and by means of water pressure when in an open position, i.e., when the drain pump is driven.

It will be apparent to those skilled in the art that modifications and variations can be made in the present invention without departing from the spirit or scope of the inventions. Thus, it is intended that the present invention covers the modifications and variations provided they come within the scope of the appended claims and their equivalents.

1. A water guide for a dishwasher having a sump, the water guide comprising:
a supply channel for supplying washing water to the sump; and
a sensor configuration, installed along said supply channel, for sensing a water level of washing water contained in the sump.

2. The water guide of claim 1, wherein said sensor configuration controls the supply of washing water via said supply channel according to the sensed water level.

3. The water guide of claim 1, wherein said sensor configuration controls the supply of washing water to the sump according to the sensed water level.

4. The water guide of claim 1, wherein said sensor configuration cuts off the supply of washing water when the water level of the sump reaches a predetermined water level.

5. The water guide of claim 1, wherein said sensor configuration drains washing water from the sump when the water level of the sump exceeds a predetermined water level.

6. The water guide of claim 1, wherein said sensor configuration senses the water level using a buoyancy of the washing water in said supply channel.

7. The water guide of claim 1, said sensor configuration comprising:
a float, movably disposed within a float chamber, said float having an elevation based on the sensed water level; and
a sensing device operated by the movement of said float.

8. The water guide of claim 7, wherein the float chamber communicates with the sump.

9. The water guide of claim 8, wherein the float chamber communicates with said supply channel.

10. The water guide of claim 7, wherein said sensing device is disposed outside said supply channel.

11. The water guide of claim 7, wherein said sensing device is a contact switch.

12. The water guide of claim 7, said sensor configuration further comprising:
a plunger, disposed between said float and said sensing device, for operating said sensing device according to the movement of said plunger.

13. The water guide of claim 12, wherein said sensing device is a contact switch and said plunger presses the contact switch when said float has a predetermined elevation within the float chamber.

14. The water guide of claim 12, wherein said plunger and said float are separated by a predetermined gap when said plunger and said float are at rest.

15. The water guide of claim 12, wherein the predetermined gap is set according a desired water level of the sump.

16. The water guide of claim 12, wherein the predetermined gap establishes a primary contact occurring between said float and a lower end of said plunger and a secondary contact occurring between an upper end of said plunger and said sensing device, the primary contact and secondary contact occurring in sequence according to the movement of said float.

17. The water guide of claim 7, said sensing device is a set of non-contact switches.

18. The water guide of claim 7, wherein said sensing device is activated by a magnetic field.

19. The water guide of claim 7, wherein said float generates a magnetic field.

20. The water guide of claim 7, wherein said switch is a reed switch.

21. The water guide of claim 7, wherein said float is cleaned by the supply of washing water to said sump.

22. The water guide of claim 21, wherein said float is disposed directly above a supply outlet of said supply channel.

23. The water guide of claim 7, said sensing device comprising:
a first switch activated by said float when the water level of the sump reaches a predetermined water level; and
a second switch activated by said float when the water level of the sump exceeds the predetermined water level.

24. The water guide of claim 23, wherein said first and second switches are disposed along one side of the movement of said float.

25. The water guide of claim 24, wherein said second switch is higher than said first switch.

26. The water guide of claim 24, wherein said second switch and said first switch are separated by a predetermined gap.

27. The water guide of claim 26, wherein the predetermined gap is set according a desired water level of the sump.

28. The water guide of claim 1, further comprising:
a water blocking unit applied to said supply channel to counter rising water levels in the float chamber and to protect electrical components of said sensor configuration from exposure to washing water escaping said supply channel.

29. The water guide of claim 28, wherein said water blocking unit protects the electrical components of said sensor configuration by collecting washing water escaping said supply channel.

30. The water guide of claim 28, wherein said water blocking unit protects the electrical components of said sensor configuration by draining washing water escaping said supply channel.

31. The water guide of claim 28, wherein said water blocking unit protects the electrical components of said sensor configuration by shunting washing water escaping said supply channel.

32. The water guide of claim 7, further comprising:
a buffer chamber, provided between said float and said sensing device, for collecting washing water escaping the float chamber.

33. The water guide of claim 7, further comprising:
an overflow drain, formed adjacent said sensing device, for draining washing water escaping the float chamber.

34. The water guide of claim 33, wherein said overflow drain communicates with a tub of the dishwasher.

35. The water guide of claim 1, further comprising:
a bypass channel, communicating with the float chamber, for shunting washing water escaping the float chamber.

36. The water guide of claim 30, wherein said bypass channel extends upwardly from said supply channel.

37. The water guide of claim 1, further comprising:
a drain channel for draining washing water from the sump.

38. The water guide of claim 37, further comprising:
a release valve assembly, disposed in said drain channel, for preventing an undesired draining of washing water from the sump.

39. The water guide of claim 38, wherein said release valve assembly selectively introduces external air to said drain channel.

40. The water guide of claim 37, further comprising:
a check valve, disposed between said drain channel and the sump, for preventing a reverse flow of washing water to the sump.

41. The water guide of claim 1, said sensor configuration comprising:
a float, movably disposed within a float chamber, said float being moved based on the sensed water level; and
a sensing device operated by the movement of said float.

42. The water guide of claim 41, wherein the float chamber has a water level corresponding to the water level of washing water contained in the sump.

43. The water guide of claim 41, wherein the float chamber communicates with said supply channel.

44. The water guide of claim 41, wherein the float chamber is vertically oriented and guides the movement of said float and wherein said float has an elevation corresponding to the vertical movement of said float within the float chamber.

45. The water guide of claim 44, wherein the sensing device is activated when the elevation of said float reaches a predetermined elevation.

46. The water guide of claim 45, wherein the predetermined elevation of said float corresponds to a desired water level of the sump.

47. The water guide of claim 41, wherein said sensing device is a contact switch and wherein the contact switch is activated by applying an external physical force, the external physical force being generated by the movement of said float.

48. The water guide of claim 41, wherein said sensing device is a set of non-contact switches and wherein the non-contact switches are activated by applying an external magnetic force, the external magnetic force being generated by the movement of said float.

49. The water guide of claim 48, wherein each of the set of non-contact switches is activated a specific movement of said float.

50. The water guide of claim 1, further comprising:
a drain channel for draining washing water from the sump, said drain channel having an inverted U-shape configuration for draining washing water from the sump.

51. The water guide of claim 50, wherein said drain channel experiences a high water pressure during the controlled draining of the sump and experiences a reduced water pressure when the controlled for draining washing water from the sump ends.

52. The water guide of claim 51, further comprising:
a release valve assembly disposed in said drain channel adjacent the apex of the inverted U-shaped configuration and configured to facilitate a controlled draining of the sump.

53. The water guide of claim 52, wherein said valve assembly selectively introduces external air to said drain channel to apply atmospheric pressure to an interior of said drain channel when the water pressure in said drain channel is reduced by the ending of the controlled for draining washing water from the sump.

54. The water guide of claim 1, further comprising:
a flow meter, disposed in said supply channel, for measuring the flow of water through said supply channel to be supplied to the sump.

55. The water guide of claim 54, wherein the measured flow of water through said supply channel to be supplied to the sump and the sensed level of washing water contained in the sump are separately determined.

56. A water guide for a dishwasher having a sump, the water guide comprising:
a casing;
a drain channel, disposed within said casing, for draining washing water from the sump;
a supply channel, disposed within said casing, for supplying washing water to the sump; and
a sensor configuration, installed along said supply channel, for sensing a water level of washing water contained in the sump.

57. A method of controlling a water level in a sump of a dishwasher using a water guide having a supply channel for supplying washing water to the sump and a drain channel for draining washing water from the sump, the method comprising:
supplying water to the sump;
detecting, at the supply channel, a water pressure resulting from said supplied water;
outputting a predetermined electrical signal based on said detected water pressure.

58. The method of claim 57, wherein said output predetermined electrical signal is applied to one of a supply valve connected to an external water source and a drain pump connected to the sump, the supply valve thereby controlling the supply of water to the supply channel and the drain pump thereby controlling the draining of washing water from the draining channel.

59. A dishwasher, comprising:
a tub for receiving articles to be washed;
a sump, disposed under said tub, for collecting and storing washing water; and
a water guide comprising:
a supply channel for supplying washing water to the sump; and
a sensor configuration, installed along said supply channel, for sensing a water level of washing water contained in the sump

60. The dishwasher of claim 59, further comprising:
at least one sprayer, communicating with said sump, for spraying the supplied washing toward articles in said tub,
wherein said tub defines a washing chamber for containing the washing water sprayed by said at least one sprayer.

61. The dishwasher of claim 60, further comprising:
a casing, coupled to an outer surface of said tub, for forming said supply channel.

62. The dishwasher of claim 61, wherein said casing has an inner space communicating with the washing chamber.
